(19) United States
(12) Patent Application Publication
(10) Pub. No.: US 2003/0014279 A1
(43) Pub. Date: Jan. 16, 2003

(54) System and method for providing patient care management

(76) Inventors: Linda L. Roman, Boca Raton, FL (US); Vincent Colwell, Martinez, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/902,992

(22) Filed: Jul. 11, 2001

(51) Int. Cl. G06F 17/60

(52) U.S. Cl. 705/2

(57) ABSTRACT

A system and method for providing a patient care plan to assist in improving health of a patient, is disclosed. Generally, a first computer is utilized comprising a transceiver, software stored within the first computer defining functions to be performed, and a processor configured by the software to perform the steps of: developing a medical template, wherein the medical template comprises at least one medical protocol that is focused toward addressing a specific attribute of a medical ailment; and customizing the medical template to develop the patient care plan, wherein the patient care plan is focused on addressing the medical ailment to improve the health of the patient. The patient care plan is periodically updated after receiving updated medical information regarding the patient.

### FIELD OF INVENTION

The present invention relates to the development of automated management protocols, and the standardized management of patient care, and more particularly to a system and method for establishing and developing custom care plans and tracking patient treatments.

### BACKGROUND OF THE INVENTION

Patient care is typically provided and directed based on a designed plan of treatment. Typically, the plan of treatment is constructed from input gathered from physicians, nursing personnel, and/or other care providers. Unfortunately, there is no automated standardization of this plan of treatment, and no standardized way of measuring patient progress. Poor patient outcomes continue and a majority of outcomes are never met. This is a major factor in increased health costs and unnecessary hospitalizations.

Current approaches taken to ensure that patient outcomes are met have been centered on the subjective assessment of the progress of a patient toward a specific medical goal. These goals are not typically standardized and often fluctuate from one care provider to the next based on their individual interpretations of accepted medical guidelines. A lack of synchronicity between prescribed medical goals may result in a patient receiving contradictory treatment from different care providers. Not only does the lack of synchronicity potentially lead to medical hazards, wherein a patient may receive contrasting medications or treatment, but the lack also potentially leads to an extended treatment period since the goals might not compliment each other.

In addition to potential hazards from contrasting medical goals, plans of treatment prescribed to obtain these goals may result in extensive patient inconvenience. As an example, if a first care provider prescribes medical office visits three times a week due to a first plan of treatment, and a second care provider prescribes medical office visits five times a week due to a second plan of treatment, more patient inconvenience is experienced by participation in the second plan. Therefore, the medical goals of the first care provider, which correspond to the first plan, provide less inconvenience.

Fortunately, it has been made possible to limit patient office visits by providing medical treatment via a home terminal, otherwise referred to as telemedicine. Telemedicine models, which incorporate an automated process of establishing a pathway based on patient diagnosis, information gathered during initial patient screening, and from information gathered for other health care modalities, increase the ability of a healthcare provider to provide the utmost care to a patient. In addition, telemedicine models also assist in correctly tracking patient care. An example of a possible telemedicine implementation is described in co-pending commonly assigned application entitled, “System and Method for Providing Medication Management, by Haines, et. al, filed on Jan. 19, 2001, and having attorney docket number 050320.1050, the disclosure of which is incorporated herein by reference.

Therefore, it is desirable to have an automated standardization of plans of treatment, and a standardized way of measuring patient progress. Further, the combination of this standardization with telemedicine techniques is also desirable.

### SUMMARY OF THE INVENTION

In light of the foregoing, the preferred embodiment of the present invention generally relates to a system and method for providing patient care management by creating a patient care plan.

Generally, describing the structure of the care management system, the system utilizes a first computer comprising a transceiver, software stored within the first computer defining functions to be performed, and a processor configured by the software. The processor performs the steps of: developing a medical template, wherein the medical template comprises at least one medical protocol that is focused toward addressing a specific attribute of a medical ailment; and customizing the medical template to develop the patient care plan, wherein the patient care plan is focused on addressing the medical ailment to improve the health of the patient.

The present invention can also be viewed as providing a method for providing patient care to assist in improving health of said patient. In this regard, the method can be broadly summarized by the following steps: developing a medical template, wherein the medical template comprises at least one medical protocol that is focused toward addressing a specific attribute of a medical ailment; and customizing the medical template to develop the patient care plan, wherein the patient care plan is focused on addressing the medical ailment to improve the health of the patient.

The invention has numerous advantages, a few of which are delineated hereafter as examples. Note that the embodiments of the invention, which are described herein, possess one or more, but not necessarily all, of the advantages set out hereafter.

One advantage of the invention is that a medical patient is assured to receive the same medical treatment from all care providers for a diagnosed illness, thereby preventing contrasting treatments and the potential hazards of receiving contrasting treatments for the same illness.

Another advantage of the invention is that patient interventions are determined, calculated, and scheduled based on concrete objective data.

Other features and advantages of the present invention will become apparent to one with skill in the art upon examination of the following drawings and detailed description. It is intended that all such additional features and advantages be included herein within the scope of the present invention, as defined by the accompanying claims.

### BRIEF DESCRIPTION OF THE SEVERAL VIEWS OF THE DRAWINGS

The present invention will be more fully understood from the detailed description given below and from the accompanying drawings of the preferred embodiments of the invention, which, however, should not be taken to limit the invention to the specific embodiments, but are for explanation and better understanding. Furthermore, the drawings are not necessarily to scale, emphasis instead being placed upon clearly illustrating the principles of the present invention. Finally, like reference numerals in the figures designate corresponding parts throughout the several drawings.

FIG. 1 is a block diagram illustrating a typical Internet based system that may operate using a TCP/IP protocol, upon which the care management system of the present invention may be implemented

FIG. 2 is a block diagram that further illustrates the care provider digital processor of FIG. 1.

FIG. 3 is a flow chart illustrating the construction and execution of a standardized patient care plan in accordance with the preferred embodiment of the invention.

FIG. 4 is a flow chart illustrating the development of a disease management pathway in accordance with the preferred embodiment of the invention.

FIG. 5 is a flow chart illustrating steps taken to ensure that a determined and applied pathway is, and remains, the most efficient pathway that can possibly be applied.

### DETAILED DESCRIPTION OF THE PREFERRED EMBODIMENT

The care system of the present invention can be implemented in software, firmware, hardware, or a combination thereof. In the preferred embodiment of the invention, which is intended to be a non-limiting example, a portion of the system is implemented in software that is executed by a computer, for example, but not limited to, a server, a personal computer, workstation, mini computer, or mainframe computer.

The software-based portion of the system, which comprises an ordered listing of executable instructions for implementing logical functions, can be embodied in any computer-readable medium for use by, or in connection with, an instruction execution system, apparatus, or device such as a computer-based system processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device. The computer-readable medium can be, for example, but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

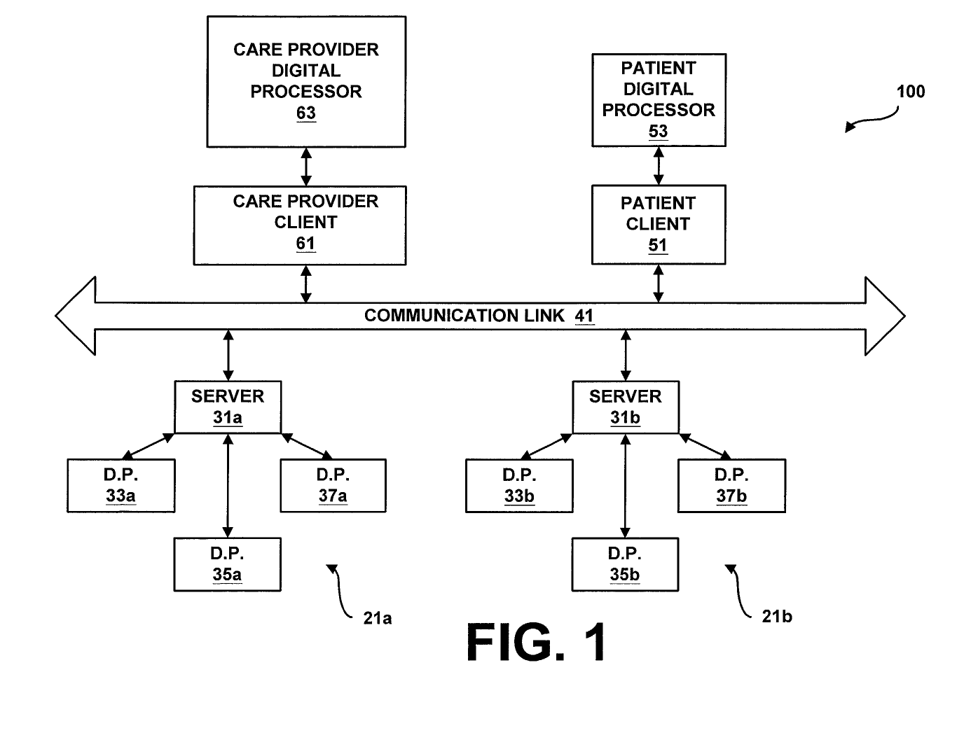

By way of example and illustration, FIG. 1 illustrates a typical Internet based system that may operate using a transmission control protocol/Internet protocol (TCP/IP protocol), upon which the care management system 100 of the present invention may be implemented. It should be noted that while the present disclosure provides implementation of the system 100 within an Internet based system, the system 100 need not be provided via use of the Internet. Instead, one of reasonable skill in the art will appreciate that the system 100 may be implemented in connection with other mediums, such as, for example, but not limited to, a local area network (LAN), or wide area network (WAN).

Further, in accordance with an alternative embodiment of the invention, the system 100 may also utilize a multi-point control unit (MCU), wherein video conferencing systems located at several locations may be interconnected for conferencing between users, as described herein below. The MCU provides for online consultation and referral capability among multiple caregivers. As known in the art, to initiate a conference using a MCU, a session host dials a number or makes some other appropriate connection such as a TCP/IP link, and then presents a conference identifier. The MCU then automatically sets up the conference and establishes TCP/IP connections to each user. Alternatively, users may then join the conference by dialing an access number to the MCU for instantaneous connection.

Referring to FIG. 1, a plurality of networks 21a, 21b are shown wherein each network 21 includes multiple digital processors 33, 35, 37. Digital processors 33, 35, 37 within each network 21 may include, but are not limited to, personal computers, mini computers, laptops, and the like. Each digital processor 33, 35, 37 is typically coupled to a host processor, or server 31a, 31b for communication among processors 33, 35, 37 within the specific corresponding network 21a, 21b.

The host processor, or server, 31 is coupled to a communication link 41 that interconnects or links the networks 21a, 21b to each other, thereby forming an Internet. As such, each of the networks 21a, 21b are coupled along the communication link 41 to enable access from a digital processor 33a, 35a, 37a of one network 21a to a digital processor 33b, 35b, 37b of another network 21b.

Various end-user clients 51, 61, two of which are shown as an example, specifically, a patient client 51 and a care provider client 61, are linked to the communication link 41, thus providing a care provider and a patient with access to the Internet. A care provider digital processor 63 is coupled to the care provider client 61 for purposes of allowing a care provider to interact with patients via the Internet, as is further explained herein below. Likewise, a patient digital processor 53 is coupled to the patient client 51 for purposes of allowing a patient to interact via the Internet, as is further explained herein below.

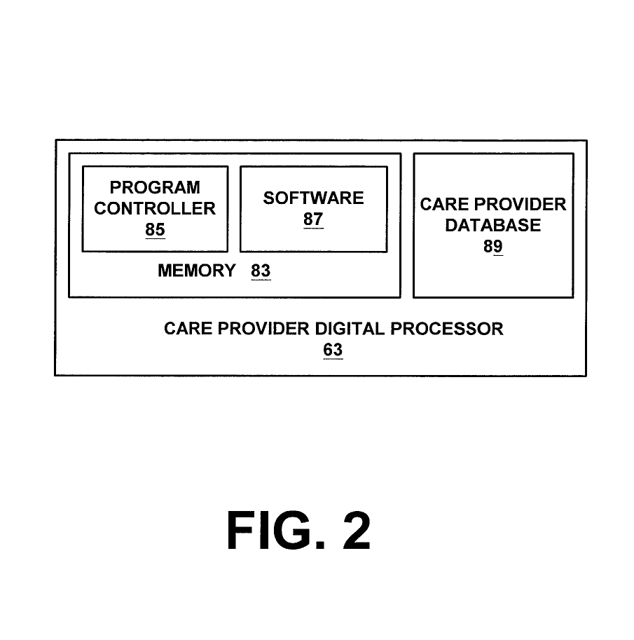

The care provider digital processor 63 stores patient information, as described with reference to FIG. 2. Logic for implementation of the care management system 100 is provided by a software program located within the care provider digital processor 63, which is operated on and connected, via the care provider client 61, to the Internet for communication among the various networks 21a, 21b and/or digital processors 33, 35, 37 and other end-users connected to the Internet via respective end-user clients. The network used by the care management system 100 may optionally be secure and encrypted for purposes of ensuring the confidentiality of information transmitted within and between the networks 21a, 21b.

FIG. 2 is a block diagram that further illustrates the care provider digital processor 63 of FIG. 1. It should be noted that the following structure of the care provider digital processor 63 is characteristic of the other digital processors 53, 33, 35, 37 within the care management system 100. As shown by FIG. 2, the care provider digital processor 63 comprises a memory 83 having a program controller 85 and care management system software 87 stored therein. The software 87 can be implemented in several modes within the networked configuration. A standard mode where the software 87 is active and online operating as a module of the care provider digital processor 63 is the most common intended use. A stand-alone analysis mode is also available where the software 87 is active and access to the patient database is available to perform editing, reporting, analysis, or maintenance functions. The program controller 85 is capable of performing functionality required by the care management system 100, in addition to locating and updating data, as described in detail herein below. The care provider digital processor 63 also comprises a care provider database 89 for storing patient information, as further described herein below.

In accordance with the preferred embodiment of the invention, the present care management system 100 allows a care provider to use standardized disease and diagnosis based protocols to guide development of a patient care plan; customize and execute standardized interventions that will ensure the utmost care for the patient; meet standardized and objectively scored outcome goals that are managed using a set number of interventions and a set number of distal visits; gather outcome based information that will be used to modify or enhance medical care plans; and, develop new care plans as required using standardized software tools.

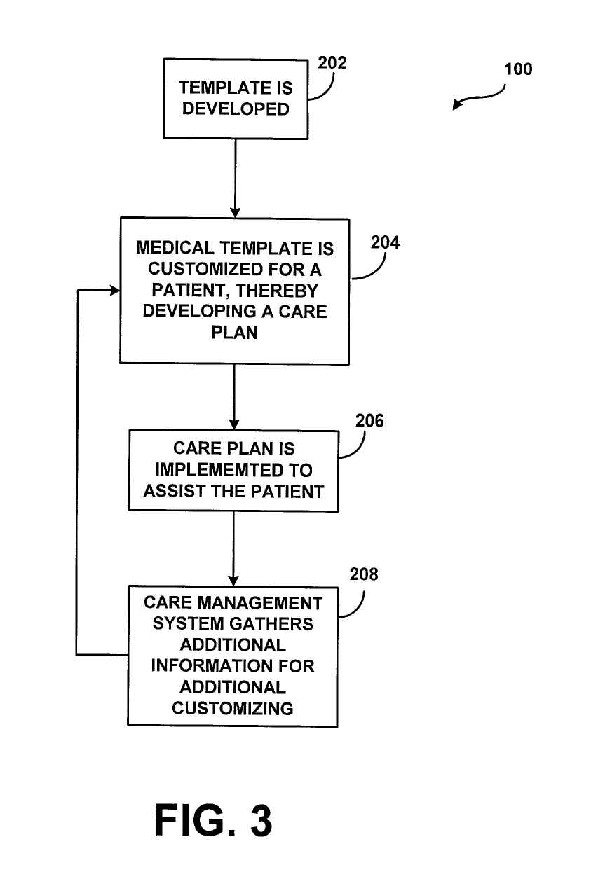

The care plan created by the care management system 100 is constructed by a protocol tool module, as explained in detailed herein below. The principal intent of the protocol tool module is to determine the course of interventions and the number of visits required to positively effect patient outcomes. FIG. 3 is a flow chart illustrating the construction and execution of a standardized patient care plan in accordance with the preferred embodiment of the invention. With regard to the flow charts of FIGS. 3-5, each block represents a module, segment, or portion of code, which comprises one or more executable instructions for implementing the specified logical function(s). In some alternate implementations, the functions noted in the blocks may occur out of the order noted. For example, two blocks shown in succession may in fact be executed in the reverse order, depending upon the functionality involved.

The protocol tool module provides necessary tools for the development of a disease management care plan. The tools can be used to develop a new care plan or modify an existing care plan. The protocol tools utilize a basic medical template that is comprised of numerous protocols that are focused on addressing a specific attribute of a disease. The template assists the care provider in establishing a number of patient visits, activities to be conducted, scoring criteria, health, and educational goals and expected outcomes, thereby developing a medical care plan, as explained in detail herein below.

Referring to FIG. 3, as shown by block 202, a medical template is developed to determine a course of medical intervention to be taken with a patient and a number of visits required to positively effect patient outcomes. In accordance with the preferred embodiment of the invention, the medical template is based on accepted care guidelines for specific disease conditions.

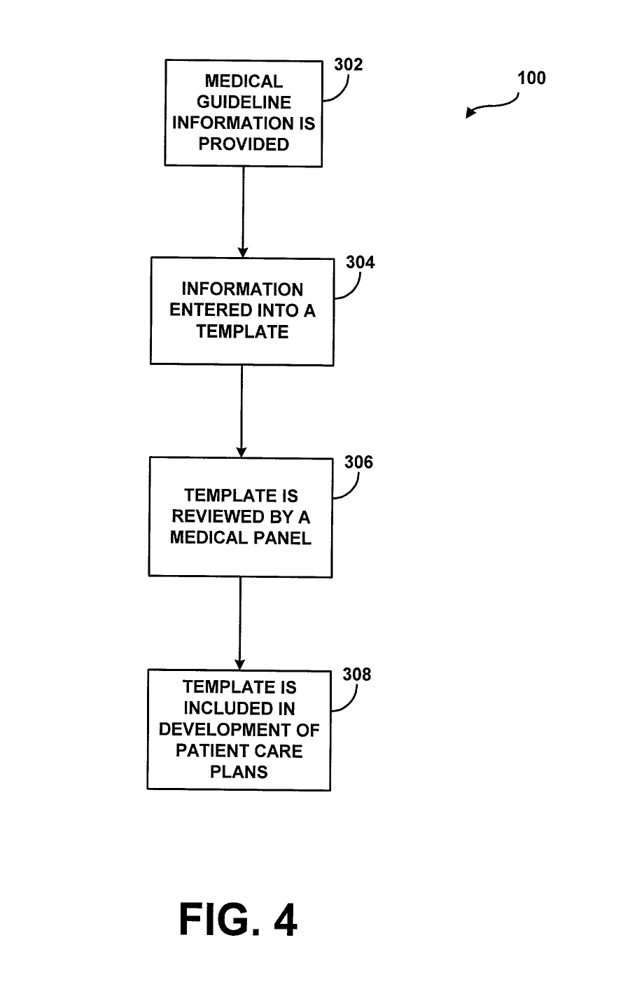

FIG. 4 is a flowchart illustrating development of the medical template, in accordance with the preferred embodiment of the invention. As shown by block 302, medical guideline information is provided to the care management system 100 based on either a written care management guideline from an accepted agency or from a medically approved standard. Therefore, the medical guideline serves as a framework for the retrieval of medical information to assist in determining a proper standard of care. As shown by block 304, the information provided is then entered into a disease management template. The template is then reviewed by a medical panel for approval so that the template may be approved as a basic standard of care for individuals having a specific disease (block 306). As shown by block 308, once approved for use, the medical template is included in the care provider database 89 for general use in the development of patient care plans, as explained herein below.

The medical template is used as the basis for the development of the patient care plan. Specifically, the template describes a course of intervention and plan of care for the enrolled patient. The template describes general guidelines for a number of visits, activities to be conducted, scoring criteria, health and educational goals, and expected outcomes, as explained in detail herein below. However, these guidelines are generic to a specific disease and not specific toward a particular patient.

The template is comprised of a series of protocols which address specific problems associated with the disease addressed. As an example, if a template is focused on addressing allergies in a patient, one protocol may be focused on reducing swelling of sinuses, while another protocol may focus on reducing eye irritation. It should be noted that when the term disease is used herein, it may represent any ailment, mental or physical, or any mental or physical area requiring positive change.

The medical template is then customized or tailored for individual patients (block 204), thereby developing a care plan. While the template may be applied directly as the patient care plan, it is preferred that the template be modified or tailored specifically for a particular patient. The tailoring or customization of the template is based upon patient history, care provider assessments, and physician orders. Patient history, care provider assessments, and physician orders may be stored within, either, the care provider digital processor 63 (FIG. 1) or the patient digital processor 53 (FIG. 1). This information may be gathered using telemedicine techniques that allow a patient to remain remote from a care provider.

As shown by block 206, the care plan is then implemented to medically assist the patient. While the care plan is being implemented, the care management system 100 continues to gather information from different locations to continuously determine a best course of care for the patient (block 208). Further description of the information gathered is provided herein below. It should be noted that this additional information may then be used to re-customize the medical template, thereby developing a revised care plan. Since the care management system 100 is implemented via a networked environment, the gathering of information is made easier than if the information had to be physically obtained. As noted herein above, the information may be gathered from numerous individuals via the Internet such as, but not limited to, physicians, patients, pharmacists, and nurses.

All modifications, changes, or other alterations to a care plan for a specific patient are preferably logged by the care provider digital processor 63 (FIG. 1) when entered into the database 89 (FIG. 2). This allows for a clear audit trail to include what has been changed, when it was changed, why it was changed, and which user changed it. Further, data fields identified as critical may be protected against unintentional errors by requiring the user of the software 87 (FIG. 2) to confirm entry. Software prompts may also be implemented to remind the user to compare the entries to any information received.

The following provides a detailed description of information stored to customize the medical template (block 204). In accordance with the preferred embodiment of the invention, the care management system 100 stores information that comprises the following interrelated data components: visits; interventions; intervention scores; elements; patient goals; and, outcomes. Information regarding each of these components is stored within the care provider digital processor 63 (FIG. 1) for use by the care management system 100 in determining a patient care plan (block 212). Any individual may input this information via the care provider digital processor 63 (FIG. 1).

The visits data component comprises a determined number of visits that is deemed necessary, which is derived from patient diagnosis, and guidelines from the medical template. Preferably, a visit includes interventions, intervention scoring, and elements. The interventions data component comprises specific activities and actions that the care provider takes to guide and assist the patient in reaching the established medical goals. The interventions data component also comprises outcomes that have been established for the patient that may be incorporated into the care plan.

The intervention scores data component comprises scoring information that is reflective of each intervention. Specifically, when each intervention is performed, it is given a score, preferably within the range of one to five. As an example, a score of one may signify that the intervention is not assisting in reaching the established medical goals. Alternatively, a score of five may signify that the intervention is helping in accordance with established medical goals. The score is based on information provided within the medical template. As illustrated herein above, the score may be used to track patient progress to assure that they are progressing as planned. The elements data component describes the specific, detail oriented actions performed by the care provider. In other words, elements are the activities that make the interventions. As each element is completed, a care provider confirms completion within the care provider digital processor 63 (FIG. 1), thereby providing a medical care history.

The patient outcomes and goals data component is specific to each patient and is automatically determined by patient diagnosis. The goals are tailored for each patient based on an initial assessment and can be modified based on patient progress during implementation of the care plan. The progress toward each goal is measured and monitored each time an intervention is completed. If the patient is not progressing as desired or if other medical conditions arise, the goals and outcomes can be adjusted as needed.

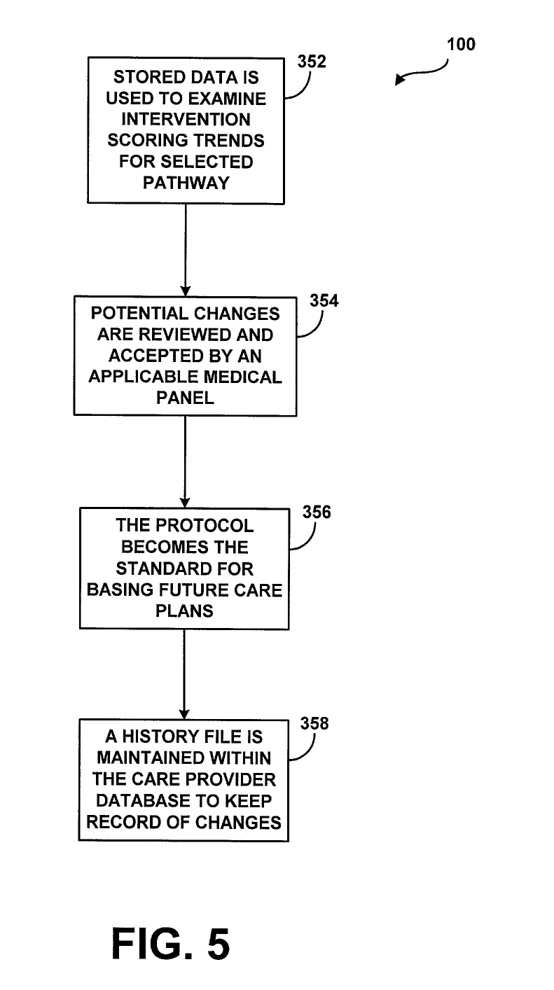

A key element of the care management system 100 is the ability to assess the effectiveness of the applied care plan over time. FIG. 5 is a flow chart that illustrates steps taken to ensure that a determined and applied care plan is, and remains, the most efficient care plan that can possibly be applied. As shown by block 352, data stored within the care provider database 89 is used as the basis to examine intervention scoring trends for the selected care plan. As shown herein above, the results of the analysis may indicate whether a care plan should or could be changed to increase efficacy or efficiency. Potential changes may be reviewed and accepted by an applicable medical panel (block 354). As shown by block 356, once approved, the care plan becomes the standard for basing future care plans. Preferably, a history file is maintained within the care provider database 89 (FIG. 2) to keep a record of changes made to the care plan and substantiation for the changes (block 358). Additionally, once a care plan is modified, the process does not stop. The new care plan is continually assessed against continuing patient interventions and modified as circumstances dictate.

Once goals are reached and interventions are completed between a patient and a care provider, prompts are provided to the care provider signifying completion of goals and/or interventions. When all interventions have been completed and all goals have been met, the care management system 100 prompts the care provider to either discharge the patient, notify the primary physician of the patient, or establish an additional plan of treatment for the patient.

In accordance with an alternate embodiment of the invention, a user may assess a patient individually against their established goals, assess a group of patients within a disease category against each other, or assess a patient or patient group against institutional, organizational, regional or national norms for a disease category. This mode can also be used to develop new care plans or include feedback adjustments to existing care plans within the database.

A second alternative embodiment of the inventions store the care plans in a separate database from patient medical records and information. As an example, the care plans may be stored within the care provider database 89, while the patient medical records may be stored within a patient database located on the patient digital processor 53 (FIG. 1). Interactions with the patient are then performed using videoconferencing links in a manner similar to that used within the preferred embodiment of the invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method for providing patient care to assist in improving health of said patient, comprising the steps of:
developing a medical template, wherein said medical template comprises at least one medical protocol that is focused toward addressing a specific attribute of a medical ailment; and
customizing said medical template to develop said patient care plan, wherein said patient care plan is focused on addressing said medical ailment to improve the health of said patient.

2 The method of claim 1, wherein said step of customizing said medical template, further comprises the steps of:
gathering medical information regarding said patient; and
conforming said medical template in accordance with said medical information regarding said patient.

3. The method of claim 1, further comprising the step of periodically performing customization of said patient care plan as a result of receiving updated medical information regarding said patient.

4. The method of claim 1, wherein said medical template is a standard of care used to address said medical ailment.

5. The method of claim 1, wherein said patient care plan further comprises, a series of medical activities to be performed to assist in treating said ailment, and a number of medical visits to be taken by said patient, with a medical professional.

6. The method of claim 5, wherein said medical visits are performed by said patient communicating with said medical professional via a communication channel such that said patient is located distant from said medical professional during said medical visit.

7. The method of claim 6, wherein said communication means is the Internet.

8. The method of claim 1, wherein said patient care plan comprises a series of interventions, wherein said interventions comprise activities that a medical professional will perform to assist said patient in achieving a predetermined medical goal.

9. The method of claim 8, wherein each of said interventions is scored in accordance with a predefined scale such that patient progress toward said predetermined medical goal may be monitored and adjusted by further customizing said patient care plan.

10. A system for providing a patient care plan to assist in improving health of a patient, comprising:
a first computer comprising;
a transceiver;
software stored within said first computer defining functions to be performed; and
a processor configured by said software to perform the steps of,
developing a medical template, wherein said medical template comprises at least one medical protocol that is focused toward addressing a specific attribute of a medical ailment, and
customizing said medical template to develop said patient care plan, wherein said patient care plan is focused on addressing said medical ailment to improve the health of said patient.

11. The system of claim 1, wherein said processor also performs the step of periodically performing customization of said patient care plan as a result of receiving updated medical information regarding said patient.

12. The system of claim 1, wherein said medical template is a standard of care used to address said medical ailment.

13. The system of claim 1, wherein said patient care plan comprises a series of medical activities to be performed for assisting in treating said ailment, and a number of medical visits with a medical professional.

14. The system of claim 13, wherein said medical visits are performed by said patient communicating with said medical professional via a communication channel such that said patient is located distant from said medical professional during said medical visit.

15. The system of claim 14, wherein said communication means is the Internet.

16. The system of claim 1, wherein said patient care plan comprises a series of interventions, wherein said interventions comprise activities that a medical professional will perform to assist said patient in achieving a predetermined medical goal.

17. The system of claim 16, wherein each of said interventions is scored in accordance with a predefined scale such that patient progress toward said predetermined medical goal may be monitored and adjusted by further customizing said patient care plan.

18. A system for providing patient care to assist in improving health of said patient, comprising:
means for developing a medical template, wherein said medical template comprises at least one medical protocol that is focused toward addressing a specific attribute of a medical ailment; and
means for customizing said medical template to develop said patient care plan, wherein said patient care plan is focused on addressing said medical ailment to improve the health of said patient.

19 The system of claim 18, further comprising means for gathering medical information regarding said patient, and means for conforming said medical template in accordance with said medical information regarding said patient.

20. The system of claim 18, further comprising means for periodically performing customization of said patient care plan as a result of receiving updated medical information regarding said patient.

21. The system of claim 18, wherein said medical template is a standard of care used to address said medical ailment.

22. The system of claim 18, wherein said patient care plan further comprises, a series of medical activities to be performed to assist in treating said ailment, and a number of medical visits to be taken by said patient, with a medical professional.

23. The system of claim 22, wherein said medical visits are performed by said patient communicating with said medical professional via a communication channel such that said patient is located distant from said medical professional during said medical visit.

24. The system of claim 23, wherein said communication means is the Internet.

25. The system of claim 18, wherein said patient care plan comprises a series of interventions, wherein said interventions comprise activities that a medical professional will perform to assist said patient in achieving a predetermined medical goal.

26. The system of claim 25, wherein each of said interventions is scored in accordance with a predefined scale such that patient progress toward said predetermined medical goal may be monitored and adjusted by further customizing said patient care plan.
